(19) United States
(12) Patent Application Publication
(10) Pub. No.: US 2026/0343089 A1
(43) Pub. Date: Oct. 29, 2026

(54) CAMERA MONITOR SYSTEM FOR A MOTOR VEHICLE AND METHOD OF CAPTURING IMAGES THEREFOR

(71) Applicant: Motherson Innovations Company Limited, London (GB)

(72) Inventor: Alexander Slama, Stuttgart (DE)

(21) Appl. No.: 19/659,196

(22) Filed: Apr. 27, 2026

(30) Foreign Application Priority Data
Apr. 29, 2025 (DE) 102025116457.6

(51) Int. Cl. H04N 23/60; H04N 23/667; H04N 23/73

(52) U.S. Cl. CPC H04N 23/64; H04N 23/667; H04N 23/73

(57) ABSTRACT

A camera monitor system (CMS) adapted for a motor vehicle is disclosed. The CMS comprises an image capturing device that can be securely mounted on the vehicle. The image capturing device comprises an image sensor. The image sensor includes at least two predefined regions of interest. Additionally, the system also comprises at least one vehicle sensor that generates signals based on vehicle operating conditions or parameters, and a driving mode of the vehicle. A controller configured to select at least one of the predefined regions of interest and automatically expose the corresponding subsets of activated pixels.

### CROSS-REFERENCE TO RELATED APPLICATIONS

This application claims the benefit of priority to German Patent Application DE 10 2025 116 457.6, filed on Apr. 29, 2025, which is incorporated herein by reference in its entirety.

### BACKGROUND

The present disclosure relates to a camera monitor system for a vehicle. The present disclosure also relates to a motor vehicle and a method for capturing images by the camera monitoring system.

A camera monitor system in or for a vehicle provides image data of surroundings of the vehicle to its driver. In specific vehicles such as a truck with a trailer, surrounding information is more important. It is necessary to provide different views with high resolution depending on different environmental conditions such as daylight condition or nightlight condition.

In an evolving landscape of automotive imaging technology, the integration of a lens or multiple lens system with a single image sensor providing various fields of view (FOVs) to the vehicle occupants also presents significant challenges in achieving optimal auto exposure (AE) settings. Traditionally, auto exposure technique is designed to focus on a particular region of interest (ROI), which restricts their ability to account for varying lighting conditions encountered across multiple FOVs.

When employing the lens or multiple lens system, where each lens captures different lighting environments, the inability to dynamically adjust the ROI for AE settings results in sub-optimal image quality. This limitation compromises the performance of advanced driver-assistance systems (ADAS) and other automotive safety features that rely on high-quality imaging.

Consequently, there exists a need for a system and method that enable adaptive auto exposure settings across the lens system in the single image sensor. The system and method should intelligently analyze various parameters of the vehicle for each FOV and adjust the exposure parameters, accordingly, ensuring that all captured images maintain optimal clarity, contrast, and detail.

Therefore, the present disclosure addresses at least partially the technological gap by providing an improved system and method for dynamic adjustment of ROI that accommodates the various vehicle parameters or vehicle modes in an automotive camera system, thereby enhancing the overall imaging performance.

US 2007/0263090 relates to a method and apparatus for automatic exposure of an in-vehicle camera, and the in-vehicle camera automatic exposure apparatus comprising a metering area setting apparatus configured to set a metering area for use in automatic exposure of a surrounding scene including at least one of a ground surface of a parking space, an area surrounding a vehicle, and a road surface in a nearby area around the vehicle such that an exposure condition determined based on the metering area becomes optimal for a particular area of interest of the image taken by the in-vehicle camera, the automatic exposure being performed using the metering area set by the metering area setting apparatus.

### SUMMARY

Against this background the object of the present disclosure is to further develop an improved camera monitor system, in particular to overcome at least some of the mentioned disadvantages. The objective of the present invention may be achieved by the camera monitoring system, and/or a method having the features of the independent claims 1 and 12 respectively. Embodiments are subject of the dependent claims.

In an embodiment, the present disclosure discloses a camera monitor system comprising an image capturing device adapted to be attached to the motor vehicle. The image capturing device comprising at least one image sensor, with the image sensor comprising at least two predefined regions of interest. Each of the at least two predefined regions of interest configured to provide a corresponding subset of activated pixels. Additionally, the camera monitor system comprising at least one vehicle sensor that is configured to generate at least one operation signal based on various vehicle operating conditions or parameters, and/or a driving mode. Further, a controller is configured for selecting one of the predefined regions of interest based on the generated operation signal and for automatically adjusting the exposure of the at least one of the subsets of activated pixels of the selected pre-defined region based on the generated operation signal. This system aims to optimize image capturing and retrieval of image information under varying vehicle operating conditions or parameters, or a vehicle operating mode, and thus reducing load on the controller. Additionally, the dynamic setting of the regions of interest for auto exposure based on relevance of the driving modes increases image quality/resolution of the CMS.

In an aspect, the image capturing device comprises at least one lens and having at least two optical paths which include a wide field of view (W-FOV) optical path and a narrow field of view (N-FOV) optical path, wherein the wide field of view of optical path is provided by the at least one lens.

In another aspect, the at least two predefined regions of interest correspond to at least one field of view (FOV) defining at least one corresponding class of area of monitoring of the CMS.

In another aspect, the at least two predefined regions of interests comprise at least one of: at least one first array of activated pixels corresponding to the narrow field of view optical path, at least one second array of activated pixels corresponding to the wide field of view optical path.

In an aspect, the at least one subset of activated pixels of the selected predefined regions of interest corresponds to the at least one first array of activated pixels.

In another aspect, the at least one subset of activated pixels of the selected predefined regions of interest may also correspond to at least one second array of activated pixels. The subset of activated pixels from both the first array and the second array of activated pixels may be used to retrieve image data based on the relevant FOVs in a particular vehicle operating environment. The ability to dynamically utilize subsets of activated pixels from both arrays enhances image quality and resolution. This flexibility ensures that the system adapts to the driving context, providing the best visual feedback to the driver. This dynamic usage of the activated pixels based on relevance of the driving modes or vehicle operating conditions increases image quality/resolution of the CMS.

In an aspect, the at least one sensor comprises at least one of: a gear sensor, a speed sensor, a steering angle measuring sensor, an ambient lighting sensor, an external environment lighting sensor, a vehicle driving mode sensor, an Advance Driving Assistance System (ADAS) activation sensor. Integration of various vehicle sensors (e.g., gear, speed, steering angle) enables comprehensive monitoring of vehicle conditions. This data enhances the system's responsiveness and accuracy, leading to safer driving experiences.

In an aspect, the driving mode of the vehicle incudes at least one of: a reverse mode, a forward mode, a lane changing mode, an autonomous mode, a parking mode, a maneuvering mode, a limp mode, a blind spot detection mode. The system's ability to recognize multiple driving modes (e.g., reverse, forward, lane change) allows it to adapt to ROIs. This customization improves user experience and enhances safety by providing relevant information based on the current vehicle operation.

In an aspect, the controller comprising an AI module that is configured to: predictively select between the at least two predefined regions of interest and auto expose the at least one subset of activated pixels of the selected predefined regions of interest based on the predefined vehicle operating conditions or parameters for a relevant field of view (FOV) stored in a database with a help of a computer aided algorithm, and/or predictively select between the at least two predefined regions of interest and auto expose the at least one subset of activated pixels of the selected predefined regions of interest based on the driving mode for a relevant field of view (FOV) stored in a database with a help of a computer aided algorithm. The AI module allows for real-time adjustments based on driving conditions and parameters, ensuring optimal image quality in varying scenarios. Additionally, by employing advanced techniques such as super-resolution and noise reduction, the AI module significantly improves the clarity and detail of images, which is crucial for safety and navigation of the vehicle. Improved image resolution and clarity can aid drivers in making better-informed decisions, particularly in critical situations, thereby enhancing road safety. The use of computer-aided algorithms facilitates faster processing and decision-making, contributing to a more responsive and efficient CMS overall.

In an aspect, the selection of the at least one of the at least two predefined regions of interest is performed by actuation of a manual or touch button. The process of selecting one or more predefined regions of interest (ROIs) is facilitated through user interaction with the manual or touch button interface. This approach allows the user to directly engage with the CMS to customize the display and focus areas based on their specific needs or preferences.

In an aspect, a method for capturing images by the camera monitor system, in particular by an image capturing device of the camera monitor system, wherein the image capturing device comprising at least one image sensor, and/or at least one lens, wherein the image sensor comprising at least two predefined regions of interest, the method comprising:
a. generating an operation signal, by at least one vehicle sensor, depending on one or more vehicle operating conditions or parameters, and/or a driving mode of the motor vehicle,
b. selecting, by a controller, between the at least two predefined regions of interest based on the operation signal generated by the sensor, and/or
c. auto exposing, by the controller, at least one subset of activated pixels of the selected predefined regions of interest.

In an aspect, the controller that manages the operation of the camera monitor system, including image processing and display control, may select at least one of the at least two predefined regions of interest based on the operation signal generated from the at least one vehicle sensor. This capability allows for dynamic adjustment of the imaging parameters based on various conditions and requirements. By this way, the system may also adapt to varying light conditions.

The present system provides an advantage where the predefined regions of interest may be judged relevant based on the vehicle parameters or driving scenario and auto exposure (AE) is performed at partially or fully for those relevant predefined regions of interest. Therefore, the present system has a dynamic setting or scenario-based setting of predefined regions of interest for auto exposure based on relevance of the different FOVs based on the vehicle parameters and driving scenario.

Furthermore, the present system is configured for presenting the captured images on a display, allowing for practical application of the enhanced imaging capabilities in vehicle operations. This adaptive approach to capture and process images enables the system to optimize resolution, field of view, and potentially improving visibility and safety for vehicle operators.

In an aspect, a motor vehicle comprising a trailer, the motor vehicle comprising the camera monitor system is disclosed.

The image capturing device referred herein as a device adapted to be attached to the motor vehicle, comprising at least one image sensor and/or lens, capable of capturing images of the vehicle's surroundings.

The field of view (FOV) referred herein as to an extent of an observable area that may be seen through the image capturing device at any given moment.

The image sensor referred herein as a component of the image capturing device that converts optical images into electronic signals.

The AI module referred herein as an artificial intelligence module configured with the controller to predictively provide the field of view on the display. Broadly, the artificial intelligence module may include any software or hardware that uses machine learning, neural networks, or other AI techniques to process and improve image data.

### BRIEF DESCRIPTION OF THE DRAWINGS

Further aspects, advantages, and outstanding properties of the present disclosure will be apparent to those skilled in the art from the following detailed description, which, together with the appended drawings, discloses exemplary embodiments of the disclosure, wherein:

FIG. 1 shows a block diagram illustrating a motor vehicle configured with a camera monitor system, in accordance with an embodiment of the present disclosure;

FIG. 2 illustrates an image sensor, in accordance with an embodiment of the present disclosure; and

FIG. 3 illustrates a method for capturing images by the camera monitor system, according to an embodiment of the present disclosure.

### DETAILED DESCRIPTION

The aforementioned objects, features, and advantages of the present disclosure will become more apparent from the following detailed description taken in conjunction with the accompanying drawings. However, various modifications may be made to the present disclosure, and the present disclosure may include various embodiments of the present disclosure. Hereinafter, specific embodiments of the present disclosure illustrated in the drawings will be described in detail.

In the drawings, the thicknesses of the layers and regions may be exaggerated for clarity. When it is indicated that an element or layer is “on top of” another element or layer, this includes both a case where another layer or element is sandwiched therebetween and a case where the element or layer is directly over the other element or layer. In principle, the same reference numbers designate the same elements throughout the specification. In the following description, like reference numerals are used to designate elements having the same function for each embodiment of the present disclosure within the same concept illustrated in the drawings.

If a detailed description of known functions or configurations associated with the present disclosure would unnecessarily obscure the core of the disclosure, a detailed description will be omitted. Also, the numerals used in the present description (e.g., first, second, etc.) are only identifiers for distinguishing one element from another.

In addition, the terms “module” and “unit” referring to elements in the following description are given or used in combination only for the sake of simplicity of writing the specification, and the terms themselves have no different meanings or roles.

Moreover, the use of a singular, such as “on”, is not to be understood as a limitation of the number of components or details of certain components. Additionally, various terms and/or expressions describing or indicating a position or directional reference, such as “top”, “bottom”, “front”, “back”, “forward”, “back”, “end”, “outside”, “inside”, “left”, “right”, “vertical”, “horizontal”, etc., may refer to one or more particular components, as generally seen from a user's view during use or operation, and such terms and/or expressions are not to be understood as limiting, but merely as a representative basis for describing the disclosure for a person skilled in the art. In addition, the suffixes “region”, “part”, “unit” for a component which is used in the following description are indicated or mixed in only with a view to simplifying the writing of the specification and have no meanings or roles which differ from one another.

Hereinafter, various embodiments of the present disclosure will be generally described.

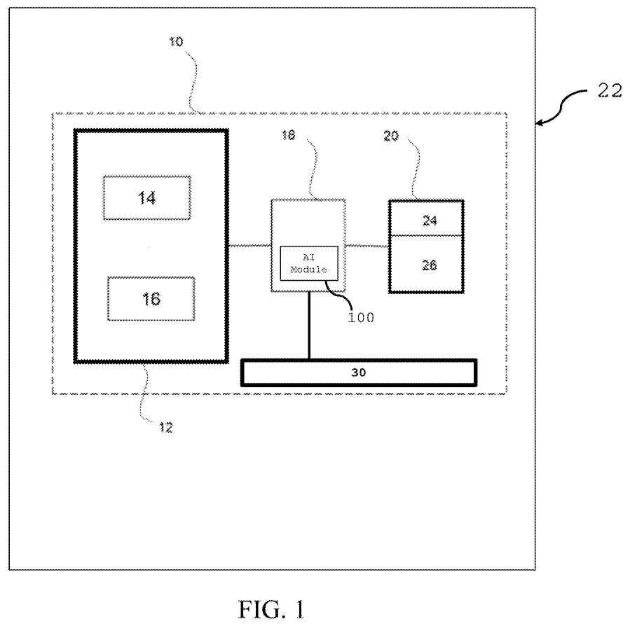

FIG. 1 illustrates a motor vehicle 22 having a camera monitor system 10. The camera monitor system 10 includes an image capturing device 12 with an image sensor 14 and at least one lens 16, at least one vehicle sensor 30, a controller 18 and a display 20. The image capturing device 12 may be attached to the motor vehicle 22. In an embodiment, the image capturing device 12 is attached to an external rear view device. In another embodiment, the image capturing device 12 is configured to view rearwardly of the vehicle and/or surrounding of the vehicle 22. In still another embodiment, the image capturing device 12 may be configured in a 2-in-1 lens configuration. In 2-in-1 lens configuration, the image capturing device 12 may have at least two optical paths; a wide field of view optical path and a narrow field of view optical path. Both the wide field of view of optical path and the narrow field of view of optical path are provided by use of a single image senor 14 and at least one lens 16. The wide field of view of optical path is provided by the lens 16. The lens 16 may have a circular geometry with a defined lens center axis. The lens 16 may also have a different geometry such as an oval shape with a defined center within the scope of this disclosure. In an embodiment, the lens 16 provides a wide field of view of optical path to the image capturing device 12.

In an embodiment, the image sensor 14 having an array of pixels and an imaging area center aligned with the lens 16, with the alignment being within common tolerances. In an embodiment, the array of pixels is divided into an active imager area defined by an array subset of activated pixels and an inactive imager area defined by an array subset of deactivated pixels. Based on the desired frame rate or image resolution to be achieved, the one or more subsets of the activated pixels may be activated. For example, for high resolution of images, all the array subset pixels of the active imager area may be activated. The image sensor 14 may also be defined with all available pixels in the array activated to send image data to the controller 18. The image sensor 14 is sized to be at least as large as the lens 16 geometry but may be larger than the lens 16. Using a larger imager 14 provides flexibility for defining and viewing the desired FOV mirror class(es) and surrounding areas as requested by the controller 18.

The controller 18 receives image data from the image sensor 14 and may control settings or image data retrieval rate from the image sensor 14. The controller 18 may also be connected to Controller Area Network (CAN) bus of the motor vehicle 22 to send or receive inputs from the vehicle sensor 30 of the motor vehicle 22. The image sensor 14 may be controlled based on inputs of the vehicle sensor 30. In an embodiment, the vehicle sensor 30 is configured to generate at least one operation signal depending on one or more vehicle operating condition/s or parameter/s, and/or a driving mode of the motor vehicle. In an embodiment, the vehicle sensor 30 may be configured to detect vehicle operating condition/s or parameter/s of the motor vehicle 22 or the CMS 10 and thereafter, the at least one operation signal based on detected vehicle operating condition/s or parameter/s is generated and sent to the controller 18 for further analysis or processing. The vehicle parameter/s may be received through the operation signal generated by the controller 18 from the vehicle sensor 30 or the vehicle parameter/s may also be determined by the controller 18 via the operation signal received from the vehicle sensor 30. In another embodiment, the driving mode may also be determined or derived through the operation signal received from the vehicle sensor 30 or the driving mode may also be obtained by the controller 18 through the operation signal received from the vehicle sensor 30. The driving mode may include a reverse mode, a forward mode, a lane changing mode, an autonomous mode, a parking mode, a maneuvering mode, a blind spot detection mode, a limp mode or any combination thereof. The at least one vehicle sensor 30 comprises at least one of: a gear sensor, a brake sensor, a speed sensor, a steering angle measuring sensor, an ambient lighting sensor, an external environment lighting sensor, a vehicle driving mode sensor, an Advance Driving Assistance System (ADAS) activation sensor and/or any combination thereof. For example, the reverse mode of the vehicle 22 may be obtained from the operation signal generated from the gear sensor. On a similar ground, the parking mode of the vehicle 22 may be determined by the controller 18 using the operation signal obtained from the gear senor and the speed sensor.

The display 20 is configured to receive image data from the controller 18 and displays the information to a vehicle operator on the display 20. The display 20 may be located inside the vehicle 22, preferably on a dashboard. The display 20 may also be located external to the vehicle 22. Further, the display 20 may also be a handheld device such as mobile device capable of receiving image data from the controller 18. The display 20 illustrates exemplary images for two different fields of view (FOVs) representing three defined mirror class areas. Shown is a mirror class II area 24 and a mirror class IV area 26. A single mirror class area, other selected mirror class areas, or images outside the defined mirror class area may also be shown in the display 20 as determined by the controller 18.

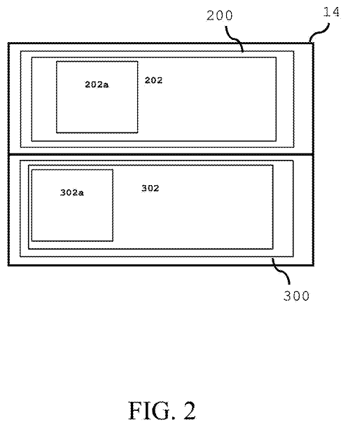

Referring to both FIG. 1 and FIG. 2, the controller 18 is configured to select at least one of the at least two predefined regions of interest 200, 300 based on the operation signal generated from the at least one vehicle sensor 30. In an embodiment, the controller 18 is also configured to auto expose at least one of the subsets of activated pixels 202a, 302a of the selected predefined regions of interest 200, 300 based on the operation signal generated from the at least one vehicle sensor 30. The at least two predefined regions of interest correspond to at least one field of view (FOV) 24, 26 defining at least one corresponding class of area of monitoring of the CMS 10. In an embodiment, the controller 18 may be configured to display the field of view (FOV) 24, 26 on the display 20.

The at least two predefined regions of interests 200, 300 comprise at least one first array of activated pixels 202 corresponding to the narrow field of view optical path, and/or at least one second array of activated pixels 302 corresponding to the wide field of view optical path. In an embodiment, the at least one subset of activated pixels 202a of the selected predefined regions of interest 200 corresponds to the at least one first array of activated pixels 202. In another embodiment, the at least one subset of activated pixels 302a of the selected predefined regions of interest 300 corresponds to at least one second array of activated pixels 302.

In an example involving class I and/or class III fields of view (FOVs), these FOVs may be provided by the narrow FOV (N-FOV) of the optical path on the display 20. For these classes, displaying a wide FOV may be redundant. Accordingly, for this specific vehicle condition and based on parameters received from the vehicle sensor 30, such as the gear sensor, the controller 18 selects the region of interest 200 that corresponds to the narrow FOV of the optical path of the image capturing device 12. The controller 18 is configured to auto-expose (AE) the activated pixels 202a corresponding to the selected region of interest 200. Therefore, the controller 18 is configured to select the first array of activated pixels 202 within the region of interest 200 that corresponds to the narrow FOV optical path and to auto-expose the activated pixels 202a within this first array. Furthermore, the controller 18 is further configured to display the FOVs derived from the exposed activated pixels 202a of the first array of activated pixels 202. This dynamic, scenario-based adjustment of the region of interest 200 for auto exposure, based on the relevance of different FOVs, enhances the image quality of the CMS 10.

In another example, during the parking mode, the lane change mode, and/or the reverse mode, the fields of view (FOVs) that need to be displayed on display 20 may be provided by the wide FOV (W-FOV) of the optical path of the image capturing device 12. For these driving modes, the W-FOV optical path may be particularly relevant. Consequently, the controller 18 is configured to select the second array of activated pixels 302 from the region of interest 300 that corresponds to the wide FOV optical path and to perform auto exposure (AE) on the subset of activated pixels 302a within this second array. Based on the requirement of frame rate and/or image resolution two or more subset of activated pixels 302a in different portions within this second array may be selected by the controller 18. Conversely to the above-described example, the narrow FOV (N-FOV) of the optical path is not applicable in this context, and therefore, the activated pixels 202 within the N-FOV area are not selected. This dynamic adjustment of the region of interest 300 for auto exposure, based on the relevance of the driving modes and/or vehicle parameters, further enhances the image quality and reduces the load on the CMS 10.

In still another example, during the blind spot detection mode, at least class III FOV may be displayed on display 20 that required N-FOV, and a blind spot area may be derived from the wide field of view (W-FOV) of the optical path. Consequently, both regions of interest 200 and 300 may be relevant. Contrary to both the examples referred hereinabove, the controller 18 is configured to select both the first array of activated pixels 202 from region of interest 200 and the second array of activated pixels 302 from region of interest 300, as necessitated for the blind spot detection mode. Additionally, the controller 18 is configured to auto expose (AE) on both subsets of activated pixels 202a and 302a from their respective regions of interest 200 and 300. The controller 18 is configured to display on the display 20 the FOVs derived from these exposed subsets of activated pixels 202a and 302a. Thus, the dynamic adjustment of regions of interest 200 and 300 for auto exposure, based on the relevance of the driving modes, enhances the image quality and resolution of the CMS 10.

In an embodiment, the selection of the at least one of the at least two predefined regions 200, 300 of interest is performed by actuation of a manual or touch button. In this particular embodiment, the process of selecting one or more predefined regions of interest (ROIs) 200, 300 may be facilitated through user interaction with the manual or touch button interface, preferably provided on the dashboard of the motor vehicle 22. This approach allows the user to directly engage with the CMS 10 to customize the display 20 with the FOVs 24, 26 based on specific needs or preferences. Once the region of interest is selected, the CMS 10 may dynamically adjust the camera settings, such as auto exposure (AE) and/or focus, to enhance image quality for the selected area. This ensures that the driver receives the most relevant information based on their current driving context.

The controller 18 may further be configured with an Artificial Intelligence (AI) module 100 to further enhance the resolution to the desired level. The AI module 10 configured to predictively select between the at least two predefined regions of interest 200, 300 and auto expose the at least one subset of activated pixels 202a, 302a of the selected predefined regions of interest 200, 300 based on the predefined vehicle operating conditions or parameters for a relevant field of view (FOV) stored in a database with a help of a computer aided algorithm. In another embodiment, the AI module further configured to predictively select between the at least two predefined regions of interest 200, 300 and auto expose the at least one subset of activated pixels 202a, 302a of the selected predefined regions of interest 200, 300 based on the driving mode for a relevant field of view (FOV) stored in a database with a help of a computer aided algorithm. The AI module 100 configured to automatically select the relevant regions of interest settings under different vehicle parameters or driving scenarios. The AI module 100 may include any software or hardware that uses machine learning, neural networks, or other AI techniques to process and improve image data to enhance the image resolution. This AI-enhanced processing may involve techniques such as super-resolution or noise reduction to improve image quality. The AI module 100 allows for real-time adjustments based on driving conditions and parameters, ensuring optimal image quality in varying scenarios. Additionally, by employing advanced techniques such as super-resolution and noise reduction, the AI module 100 significantly improves the clarity and detail of images, which is crucial for safety and navigation of the vehicle. Improved image resolution and clarity aids drivers in making better-informed decisions, particularly in critical situations, thereby enhancing road safety. The use of computer-aided algorithms facilitates faster processing and decision-making, contributing to a more responsive and efficient system overall.

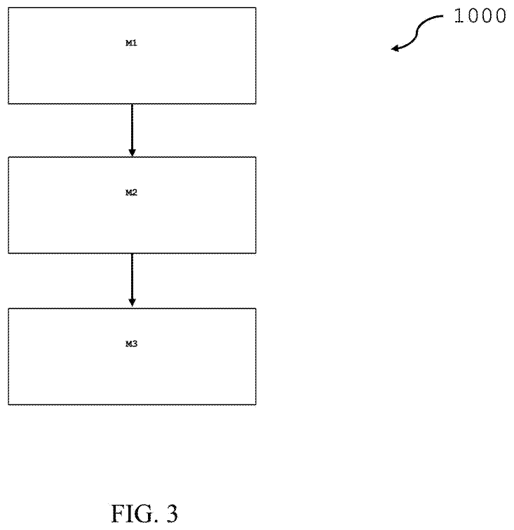

FIG. 3 illustrates a method 1000 for capturing images by the camera monitor system 10 having the image capturing device 12. The image capturing device 12 comprising at least one image sensor 14, and/or at least one lens 16. The image sensor 14 comprising at least two predefined regions of interest 200, 300. The image capturing device 12 having at least two optical paths, wherein the optical paths include a wide field of view optical path and a narrow field of view optical path, wherein the wide field of view of optical path is provided by the lens 16. The at least two predefined regions of interests 200, 300 comprise: at least one first array of activated pixels 202 corresponding to the narrow field of view optical path, and/or at least one second array of activated pixels 302 corresponding to the wide field of view optical path. Step M1 involves generating an operation signal, by at least one vehicle sensor 30, depending on one or more vehicle operating conditions or parameters, and/or a driving mode of the motor vehicle 22. Step M2 involves selecting, by a controller 18, between the at least two predefined regions of interest 200, 300 based on the operation signal generated by the vehicle sensor 30. Thereafter, step M3 involves auto exposing, by the controller, at least one subset of activated pixels 202a, 302a of the selected predefined regions of interest 200, 300.

The present disclosure provides lower cost by utilizing the image capturing device 12 in 2-in-1 configuration than two separate image capturing devices (cameras) at one side of the motor vehicle 22 and provide best image quality under the different vehicle conditions and/or parameters, or the vehicle or CMS modes on the other hand. Moreover, this adaptive functionality enables the CMS 10 to optimize image quality and relevance in real-time, thereby improving the overall driving experience and safety.

### REFERENCE SIGNS LIST

10 Camera monitor system (CMS)
12 Image capturing device
14 Image sensor
16 Lens
18 Controller
20 Display
22 Motor vehicle
24 Field of view (FOV)
26 Field of view (FOV)
30 Vehicle sensor
200 Predefined region of interest (first region)
300 Predefined region of interest (second region)
202 First array of activated pixels (narrow field of view)
202a Subset of activated pixels (from region 200)
302 Second array of activated pixels (wide field of view)
302a Subset of activated pixels (from region 300)
100 AI module
1000 Method
M1 Step of method
M2 Step of method
M3 Step of method

What is claimed is:

1. A camera monitor system (CMS) for a motor vehicle, the camera monitor system comprising:
at least one image capturing device comprising at least one image sensor and configured to be attached to the motor vehicle, wherein the image sensor comprises at least two predefined regions of interest and each of the at least two predefined regions of interest are configured to provide a corresponding subset of activated pixels;
at least one vehicle sensor configured to generate at least one operation signal depending on one or more vehicle operating conditions or parameters, and/or a driving mode of the motor vehicle; and
a controller configured to:
select at least one of the at least two predefined regions of interest based on the generated operation signal; and/or
auto expose at least one of the subsets of activated pixels of the selected predefined regions of interest based on the generated operation signal.

2. The camera monitor system according to claim 1, wherein the image capturing device comprises at least one lens and having at least two optical paths which include a wide field of view optical path and a narrow field of view optical path, wherein the wide field of view of optical path is provided by the lens.

3. The camera monitor system according to claim 1, wherein the at least two predefined regions of interest correspond to at least one field of view (FOV) defining at least one corresponding class of area of monitoring of the CMS.

4. The camera monitor system according to claim 1, wherein the at least two predefined regions of interest comprise at least one of:
(i) at least one first array of activated pixels corresponding to the narrow field of view optical path, and/or
(ii) at least one second array of activated pixels corresponding to the wide field of view optical path.

5. The camera monitor system according to claim 4, wherein the at least one subset of activated pixels of the selected predefined regions of interest corresponds to the at least one first array of activated pixels.

6. The camera monitor system according to claim 4, wherein the at least one subset of activated pixels of the selected predefined regions of interest corresponds to at least one second array of activated pixels.

7. The camera monitor system according to claim 1, wherein the at least one sensor comprises at least one of:
a gear sensor,
a speed sensor,
a steering angle measuring sensor,
an ambient lighting sensor,
an external environment lighting sensor,
a vehicle driving mode sensor, or
an Advance Driving Assistance System (ADAS) activation sensor.

8. The camera monitor system according to claim 1, wherein the driving mode of the vehicle includes at least one of:
a reverse mode,
a forward mode,
a lane changing mode,
an autonomous mode,
a parking mode,
a blind spot detection mode,
a maneuvering mode, or
a limp mode.

9. The camera monitor system according to claim 1, wherein the controller comprises an AI module that is configured to:
(i) predictively select between the at least two predefined regions of interest and auto expose the at least one subset of activated pixels of the selected predefined regions of interest based on the predefined vehicle operating conditions or parameters for a relevant FOV stored in a database with a help of a computer aided algorithm, and/or
(ii) predictively select between the at least two predefined regions of interest and auto expose the at least one subset of activated pixels of the selected predefined regions of interest based on the driving mode for a relevant FOV stored in a database with a help of a computer aided algorithm.

10. The camera monitor system according to claim 1, wherein the selection of the at least one of the at least two predefined regions of interest is performed by actuation of a manual button.

11. A motor vehicle comprising the camera monitor system according to claim 1.

12. A method for capturing images by a camera monitor system, wherein the image capturing device comprises at least one image sensor, and/or at least one lens, wherein the image sensor comprises at least two predefined regions of interest, the method comprising:
(i) generating an operation signal, by at least one vehicle sensor, depending on one or more vehicle operating conditions or parameters, and/or a driving mode of the motor vehicle;
(ii) selecting, by a controller, between the at least two predefined regions of interest based on the operation signal generated by the sensor; and
(iii) auto exposing, by the controller, at least one subset of activated pixels of the selected predefined regions of interest.

13. The method claimed according to claim 12, wherein the image capturing device has at least two optical paths, wherein the optical paths include a wide field of view optical path and a narrow field of view optical path, wherein the wide field of view optical path is provided by the lens.

14. The method claimed according to claim 12, wherein the at least two predefined regions of interest comprise:
(i) at least one first array of activated pixels corresponding to the narrow field of view optical path, and/or
(ii) at least one second array of activated pixels corresponding to the wide field of view optical path.

15. A camera monitor system (CMS) for a motor vehicle, the camera monitor system comprising:
at least one image capturing device comprising at least one image sensor and configured to be attached to the motor vehicle, wherein the image sensor comprises at least two predefined regions of interest and each of the at least two predefined regions of interest are configured to provide a corresponding subset of activated pixels;
at least one vehicle sensor configured to generate at least one operation signal depending on one or more vehicle operating conditions or parameters, and/or a driving mode of the motor vehicle; and
a controller configured to:
select at least one of the at least two predefined regions of interest based on the generated operation signal; and/or
auto expose at least one of the subsets of activated pixels of the selected predefined regions of interest based on the generated operation signal,
wherein the controller comprises an AI module that is configured to predictively select between the at least two predefined regions of interest and auto expose the at least one subset of activated pixels of the selected predefined regions of interest.
